(19) United States
(12) Patent Application Publication
(10) Pub. No.: US 2008/0278366 A1
(43) Pub. Date: Nov. 13, 2008

(54) Method and Device for Determining the Vehicle Class of Vehicles

(76) Inventor: Andreas BEHRENS, Langenfeld (DE)

Correspondence Address: DUANE MORRIS LLP - NY;PATENT DEPARTMENT, 1540 BROADWAY, NEW YORK, NY, 10036-4086, US

(21) Appl. No.: 12/118,342

(22) Filed: May 9, 2008

(30) Foreign Application Priority Data
May 7, 2007 (DE) DE102007022372.4

(51) Int. Cl. G01S 13/58; G01S 13/08

(52) U.S. Cl. 342/109; 342/118

(57) ABSTRACT

The invention relates to a method and device with which a vehicle traveling through a radar cone is classified by means of length criteria. The length criteria are formed by the difference of the driven distance that the vehicle covers, during which it reflects the radar beam, and the passage distance of the vehicle through the radar cone, which gives a more or less precise measurement for the vehicle length according to the accuracy of the determined passage distance. For determining the passage distance, range values are derived from the radar signals.

### FIELD OF THE INVENTION

The invention relates to a method for classifying a vehicle as it is driven past a radar beam directed onto a roadway.

### BACKGROUND OF THE INVENTION

Such a method is known according to the class from Patent Application No. EP 0 067 905 A1.

Doppler radar systems are used in traffic measurement technology especially for monitoring and enforcing legal speed limits for vehicles. Here it can be of interest not only to detect the speed of a vehicle, but also to classify the vehicle.

EP 0 067 905 A1 relates to a method and to a device in which the speed of a measured vehicle and discrimination criteria for assigning the vehicle to a vehicle class are derived by means of the evaluation of signals of a Doppler radar speed measurement device. In this way it becomes possible to trigger a camera when different maximum speeds allocated to different vehicle classes are exceeded. As discrimination criteria, criteria for the vehicle length are detected, determined by the number of emitted radar pulses that are reflected by the vehicle as it drives past.

The application of the measurement method described here on a roadway with several lanes shall be explained with reference to FIG. 1.

FIG. 1 shows, for example, the passage of three vehicles A1, A2, A3, which travel through a radar cone 4 with a beam spread angle α, whose main beam is oriented at a positioning angle β to the roadway direction. The positioning angle β can also be realized by a squint angle of the radar sensor. Here, the vehicles A1, A2, A3 each cross through the radar cone 4 in a different lane and consequently at different ranges to the radar device 5. The vehicles A1, A2, and A3 appear at respective time points t1ₐ, t2ₐ, and t3ₐ at respective ranges E1ₐ, E2ₐ, and E3ₐ, in the radar cone 4 and leave the radar cone 4 at respective time points t1_{b}, t2_{b}, and t3_{b}, at respective ranges E1_{b}, E2_{b}, and E3_{b}. In the meantime, due to the increasing width of the radar cone 4, they each cover different driven distances s1, s2, and s3, respectively, i.e., driven distances of different lengths, as a function of the range E to the radar device 5.

From the number of reflected radar pulses between respective entry and exit times tₐ and t_{b}, and the knowledge of a fixed distance e (product from half the wavelength of the radar beam and cos β), which a vehicle A1, A2, or A3 covers during a radar pulse, the corresponding driven distance s1, s2, or s3, i.e., its length, can be determined, during which the radar device 5 receives reflected radar pulses.

Because the measurement begins with the entry of the front of the vehicle and ends with the exit of the rear end, the driven distances s1, s2, and s3 are combinations of the corresponding passage distance d1, d2, and d3, respectively, through the radar cone 4, i.e., the length, and the corresponding vehicle length L1, L2, and L3, respectively (see FIGS. 2 and 3).

The vehicle length L can be accurately determined from the driven distance s only when all of the vehicles pass through the same passage distance d or else when the passage distance d is known and thus the vehicle length L can be determined from the corresponding driven distance s.

However, because the goal is not primarily to determine the vehicle length L, but instead to use it as means to be able to classify the measured vehicle, it is sufficient to determine length criteria that allow the vehicle to be assigned unambiguously to only one vehicle class.

From DE 693 17 186 T2 (application corresponding to U.S. Pat. No. 5,402,346 A), a system for determining at least one traffic control parameter for vehicles is known.

To enable simultaneous monitoring of all the lanes, a pulsed radar beam is directed onto the roadway. The generated radar beam (called diagram here) is narrow according to the horizontal beam spread angle (called side angle here) and is inclined by a horizontal positioning angle (also called side angle here) to the roadway.

The vehicle length is designated as one of the determinable traffic control parameters.

This is formed from the product of the determined vehicle speed and the duration of the presence of the vehicle in the radar cone minus the path that the vehicle covered when driving through the radar cone (passage path). This passage path is formed as a fixed value from the length of a given range window and the cosine of the horizontal positioning angle and the horizontal beam spread angle.

Whereas in EP 0 067 905 A1, where length discrimination of the vehicles is determined just with reference to the driven distances s detected for the vehicles—in DE 693 17 186 T2, the driven distances are also detected, but by means of the determined speed and the duration of the presence of the vehicle in the radar cone—in DE 693 17 186 T2, these driven distances are corrected by a fixed value.

The accuracy of the discrimination criteria of vehicle length is therefore not improved. In both cases, the obtained length values are equally subject to error because the passage distances for vehicles traveling at different ranges to the radar device are not constant. The greater the horizontal beam spread angle of the radar cone, the greater the error.

In EP 0 067 905 A1, it is shown, for example, that with the determination of the length criteria proposed here, namely the driven distance s across the number of radar pulses, a Pkw [passenger car] with a length of 4.5 m and a width of 1.5 m and a minivan with a length of 6 m and a width of 2 m can be distinguished from an Lkw [truck] with a length of 10 m and a width of 2.5 m, even if the vehicles are located in a first, second, or third lane. However, it is also clear that the discrimination is possible only due to the large differences in length, namely, on the one hand, 4.5 m or 6 m and, on the other hand, 10 m, which are greater than the tolerance range of the passage distances d across the roadway width. A Pkw at 4.5 m and a minivan at 6 m cannot be reliably distinguished if the vehicles are traveling anywhere on the roadway width, i.e., in different lanes.

For applications in which more than the three lanes specified here as an example are to be monitored or a finer discrimination than only Lkws and other vehicles is desired, the determination of length criteria by means of the determination of the driven distance s, e.g., by means of the number of reflected radar pulses according to EP 0 067 905 A1, is not sufficiently accurate.

In addition to the application presented, classification of vehicles can be of interest for speed limits dependent on vehicle class in order to monitor, in addition to or instead of, the speed indication, e.g., unauthorized use of a street not permitted for transporting of heavy loads, to detect the use of lanes by different vehicle classes for statistical purposes, or to identify vehicles subject to tolls insofar as this toll requirement is determined by vehicle class. It also can be of interest to identify motorcycles or three-wheeled vehicles, which provide identification only on the rear end, in order to take an additional rear-end photograph restricted to this vehicle in the case of a speed violation. The vehicle length could also be a criterion, in order to assign a measured speed to a vehicle in a group of vehicles of different length or to verify an already determined assignment. For the last application, the most precise vehicle length determination possible would be of use, in order to also classify, e.g., Pkws according to vehicle types of different length.

The method disclosed in Patent EP 0 935 764 B1 does not relate to a method with which a classification of vehicles is performed, but instead to a method in which the range is also detected at the same time as the speed, whereby this solution gains relevance to the solution according to the invention.

The detected range is used to assign the vehicle to a lane in order to identify the measured vehicle in a group of vehicles traveling in different lanes.

For the range measurement by means of radar technology, pulsed radar devices and continuous radar devices with frequency-modulated continuous radar signals are known. In both cases, the range is not actually measured, but instead derived from different measurement parameters.

Continuous radar devices are also known which also permit the derivation of a measurement angle to the radar axis by means of the speed and the range.

In the following description, when the discussion is of measured values and a measured speed, measured range, or a measured measurement angle, a derived speed, range, or measurement angle should be understood.

Pulsed radar devices determine the range, i.e., the radial distance of reflective vehicle parts to the radar antenna by means of a propagation time measurement and derive the speed from the propagation time difference between successive measurements.

With a continuous radar device, a continuous radar beam that has a constant amplitude and frequency is emitted in a known way. As it is reflected from a moving object, such as a vehicle, this radar beam undergoes a frequency shift dependent on the speed of the vehicle. The beam portion that is reflected back into the radar device or onto the radar antenna is compared with the transmitted radar beam, and a frequency difference, the so-called Doppler frequency, is formed, which is proportional to the speed of the vehicle.

With the emission of a radar beam in different frequencies, frequency-shifted reflected beams are obtained, from whose phase difference the range is derived.

The speed and the range are thus determined in a common detection by means of a measurement principle in a common measurement procedure, with which a unique assignment of the measured values to each other is guaranteed.

Naturally, a measured value determination is also possible by means of different measurement principles, e.g., the detection of the speed by means of the Doppler radar principle and the detection of the speed by means of a pulse propagation time measurement, an example of which is specified in EP 0 935 764 B1.

For the Doppler radar principle, in contrast to the speed measurement, which is possible to a very precise degree, the variance of the range measurement values is very large. The point reflections, which reach from a vehicle to the radar antenna, extend to the entire vehicle contours on which the radar cross section is projected. The radar cross section projected onto a vehicle driving through the radar cone changes as a function of the corresponding geometry of the vehicle and also its position in the radar cone beginning from the entry into the radar cone up to the exit from the radar cone. At each measurement time point, a sum of measured values (measured value set) made up of partial reflections is detected by the receiver. A measured value is formed from these measured values, e.g., by means of averaging. For the following description, the measured range should be understood to be this formed measured value.

### SUMMARY OF THE INVENTION

The invention is based on the problem of refining a method for classifying vehicles with reference to length criteria and a corresponding device in such a way that the vehicle length can be derived more accurately, in order to be able to perform a finer classification of the vehicles.

This problem is solved by a method with the features of Claim 1 and for a device with the features of Claim 13. Advantageous refinements are described in the subordinate claims.

It is essential to the invention that the length criteria will be improved by limiting the tolerance width for the passage distance d, in that the passage distance d is determined by means of the detection of range values E and thus the vehicle length L can be derived more accurately.

### BRIEF DESCRIPTION OF THE DRAWINGS

The invention shall be explained in more detail below using examples with reference to the drawings, in which

FIG. 1 is a basic diagram for explaining the measurement situation;

FIG. 2 is a basic diagram for detecting measured values of a vehicle A2 in a second lane away from a radar device 5 according to a first embodiment;

FIG. 3 is a basic diagram for detecting measured values of a vehicle A3 in a third lane away from a radar device 5 according to a second embodiment; and

FIG. 4 is a schematic for a device.

### DESCRIPTION OF EMBODIMENTS

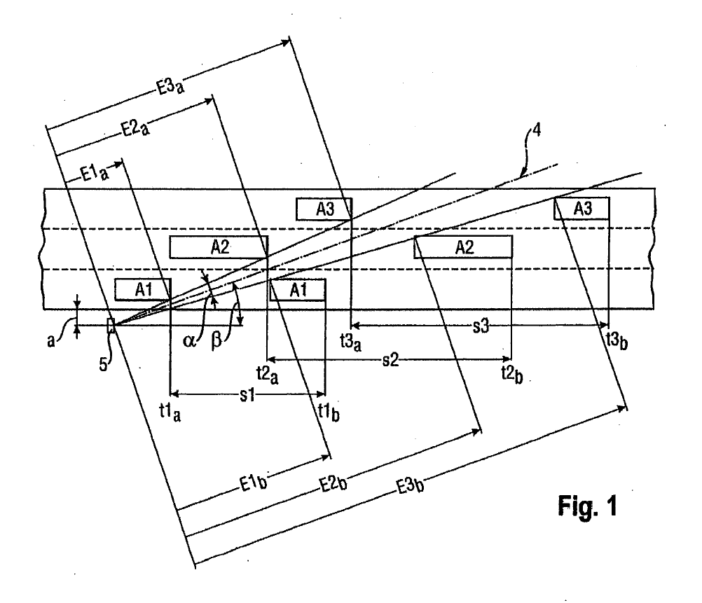

The method according to the invention represents a refinement of a method according to EP 0 067 905 A1. Identical to the method described here, as it was described in the description of the prior art in detail with reference to FIG. 1, the driven distance s is determined with reference to the number of reflected radar pulses, and the distance e that the vehicle A covered during a radar pulse is determined.

Alternatively, the driven distance s can be determined from the passage time (=t_{b}−tₐ) and the measured speed v.

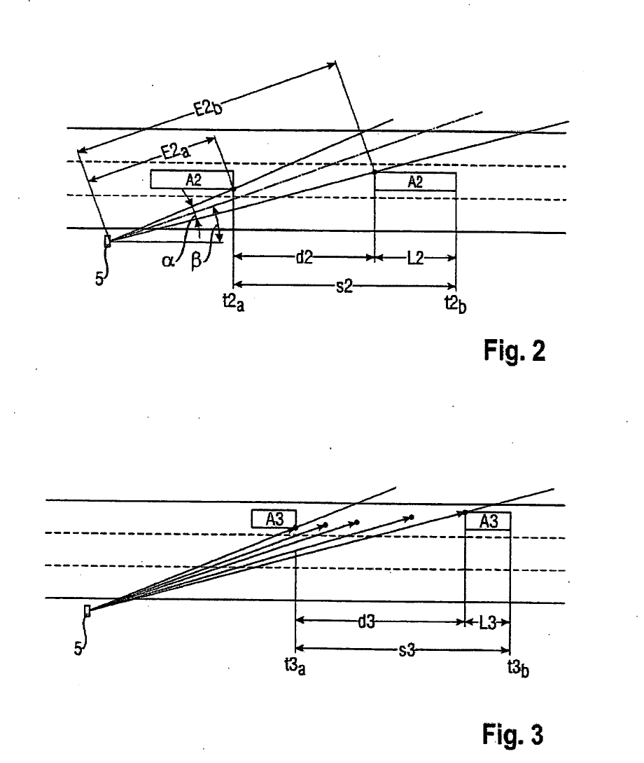

For performing the method, a radar device 5 with a distance a to the roadway is positioned at an acute horizontal positioning angle β of the radar axis to the roadway direction next to a roadway with several lanes. The positioning angle β can also be realized by a squint angle of the radar device 5. For a beam spread angle α of the radar cone 4, e.g., a vehicle A2 traveling in the middle of the second lane passes through the radar cone 4 at ranges from E2ₐ to E2_{b} across a passage distance d2 (FIG. 2).

In contrast to the prior art, where only the driven distance s is determined and only this is used as a length criteria for the classification, for the method according to the invention, the tolerance range of the passage distance d is limited, in that at least one range value E is measured.

The limitation of the tolerance range of the passage distance d with only one range value E is possible because a passage distance d, which was determined in advance and which is defined by the beam spread angle α, the positioning angle β, the distance a of the radar device 5 to the roadway, and an average vehicle width, is allocated to this range value E. The determined driven distance s minus the passage distance d then gives a measure of the vehicle length L. The determination of the passage distance d with reference to only one range value E is very coarse, but in comparison with the prior art, it limits the range of lengths for the passage distance d, which is why the tolerance range for the vehicle length L becomes comparatively smaller.

To be able to reach a conclusion on a passage distance d directly via the range E, in a first embodiment with reference to FIG. 2, a measured value detection of the range E at the time point of the entry t2ₐ of a second vehicle A2 into the radar cone 4 and at the time point of the exit t2_{b} of this vehicle A2 from the radar cone 4 should be measured. The passage distance d2 is here given from the formula d2=cos(β−α/2)·E2_{b}−cos(β+α/2)·E2ₐ.

By subtracting the passage distance d2 from the driven distance s2 determined in a known way, the vehicle length L2 is given.

Through a more accurate determination of the driven distance s, the tolerance range for the vehicle length L is considerably reduced. To view the driven distance s as a limited straight line, however, is an idealization, in which the vehicle A, considered as reduced to a point, exactly maintains its direction of travel, i.e., the path that the vehicle A travels describes is a straight line.

Even if the vehicle A maintains its direction of travel, but its extent past the vehicle width is taken into consideration, then the range values E no longer describe a straight line but in a curve, whose length is necessarily longer than the straight line, i.e., the actual passage distance d is longer than the passage distance d determined with a described two-point measurement. For changes in the direction of travel, the actual passage distance d could also be extended.

According to a second embodiment, the range measurement could also be determined over the entire passage time, in order to determine from it the vehicle path described by vehicle A and thus the driven distance s, i.e., its length, with even more precision.

In FIG. 3, five measurement time points are shown. It is clear that the range values E after entry lie on a straight line parallel to the direction of travel as long as the vehicle A has not yet completely entered into the radar cone 4. Then the range value E quickly increases, which is based on the fact that the rear end reflects as a reflector in addition to the vehicle side. From this it also becomes clear that different vehicle contours deliver different signal profiles, which shall be discussed in more detail further below.

The range values E do not follow the described rule when the vehicle A does not travel constantly in the direction of travel of the roadway.

With the entry of a vehicle A into the radar cone 4 (measurement range), the speed v, radial distance a (range E), and optionally the measurement angle to the radar axis of vehicles are determined by means of the continuous measurement of reflection signals originating from these individual vehicles A.

The continuous speed measurement or the range measurement is performed, as already described, by taking advantage of the Doppler radar effect or corresponding to the frequency shift keying principle in evaluation of the phase difference of reflected radar signals of different frequency.

The angle measurement optionally takes place by means of two receiving antennas by means of a triangulation measurement. For this purpose, for example, a planar antenna according to DE 10 2004 040 015 B4 can be used.

Because the speed v, the range E, and the measurement angle are derived from a measurement, the measurement values can be uniquely assigned to each other.

For each measurement process, a value pair of the speed v and range E or a value triplet of the speed v, range E, and measurement angle is produced for each vehicle A in the radar cone 4.

The greater the number of measured values determined over the same passage distance d, the greater the accuracy of a conclusion that can be made regarding the vehicle path and thus the actual passage distance d.

Under consideration of this relationship, it follows that as many measurements as possible are performed for high accuracy.

The shorter the passage distance d for the same tolerance width of the range value E and thus the absolute deviation of the passage distance d, the smaller the tolerance width for the determined vehicle length L.

Under consideration of this relationship, it follows that the measurement area is limited for reasons of improved accuracy, in that the area is limited to a smaller angular area than is given by the beam spread angle α. For this purpose, as already mentioned, the measurement angle is also detected for the range E.

With the continuous repetition of the measurement process (tracking algorithm), the value pairs or value triplets are tested continuously for their likelihood, in that the actual values are compared with desired values. The desired values are given from the assumption that a vehicle A at constant speed v maintains its direction of travel unchanged and from the knowledge of the time distance of the measurement processes. Here, individual measurement values that do not appear to be likely, i.e., speeds v, ranges E, or measurement angles that would be impossible to assign to a measured vehicle A at the next measurement time point, e.g., due to multiple reflections or reflections from stationary objects, are filtered out, i.e., they are not included in averaging. By means of the continuous adaptation of the desired values for the value pairs or value triplets to the actual values for the value pairs or value triplets, for each individual vehicle A, a sequence of value pairs or value triplets are obtained, which represent the vehicle path of the given vehicle A.

The measurements are performed, e.g., over a time period from ca. 100 ms up to a few seconds at an interval, e.g., of 20 ms according to the speed v between the entry into and exit out of the radar cone 4, by means of which the vehicle paths can be defined with high accuracy.

From the determination of only one range value E, which allows as a criterion a coarse determination of the passage distance d, up to the determination of the vehicle path, which corresponds quite accurately to the actual passage distance d, the passage distance d can be determined with increasing accuracy and thus the vehicle length L can be determined from the driven distance s with more accurately.

A higher accuracy, however, is also associated with higher expense in terms of equipment and computation, which is why, according to the application and the resulting accuracy requirements, one or the other construction is advantageous.

In each case, sufficiently accurate length criteria are determined for each application, which determines the vehicle length L with more or less accuracy in order to classify the vehicles A.

The determined vehicle length L is then compared with vehicle lengths Lₘ or vehicle length ranges that are typical for the individual vehicle classes, in order to assign the vehicle A to a certain class, e.g., motorcycle, Pkw, Lkw.

Advantageously, the classification is verified by means of determining a signal form M allocated to the vehicle A. Due to the different properties of the vehicles A, e.g., the reflectivity of the surface and the profile irradiated by the radar beam in magnitude and form, these signal profiles generate a different profile and amplitude in the frequency or time domain. Through empirical tests, in practice, signal forms Mₘ that are typical for each vehicle class are determined and stored as patterns. The signal forms M actually obtained during measurement are then compared with these typical signal forms Mₘ and assigned to these forms.

In this way, the classification performed by means of the length criterion is possible, without additional measurements, but only the already obtained measured values.

Identical to the known method, the measured speed v can be compared with a maximum speed and when this maximum speed is exceeded, a signal can be output, which triggers a camera 10 connected to the radar device 5, in order to take a photograph, on which is imaged the vehicle A making the traffic violation.

According to the invention, this signal is then output only when the speed v has exceeded the maximum speed allocated to the vehicle class to which the measured vehicle A can be assigned. In the photograph, in addition to the data known from the prior art, e.g., date, clock time, speed, and optionally range E, the vehicle class and/or a value for the vehicle length L are also indicated. The information on the vehicle length L and/or the vehicle class can also be used as verification for which vehicle A in a group of vehicles A was measured. For such an application, e.g., the most accurate length determination possible is important, by means of which vehicles A within a class could also be differentiated from each other if they differ sufficiently in length.

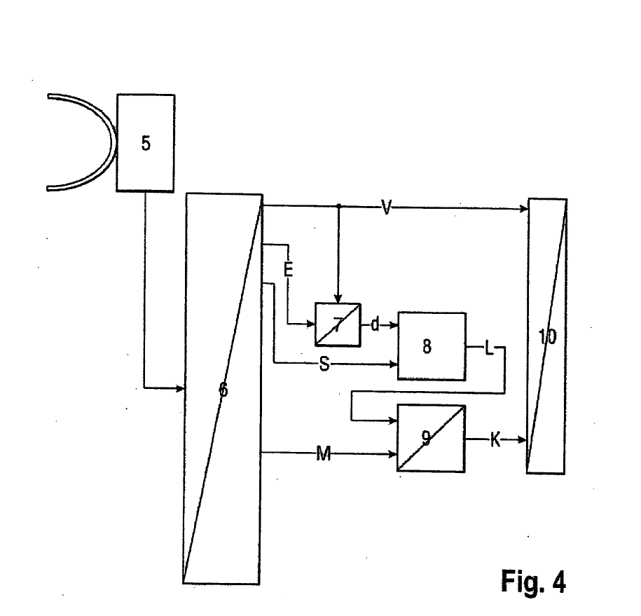

Below, a device according to the invention, with which a method according to the invention can be performed, will be described with reference to FIG. 4.

The device includes a radar device 5, which transmits and receives continuous radar signals, and also an evaluation and memory unit 6, which is connected to the radar device 5 and which is designed so that, from the received signals, it forms measurement values for the speed v, the range E, and the driven distance s, and also stores the signal form M and the time points of entry tₐ and exit t_{b}.

The evaluation and storage unit 6 is connected to a computing unit 7, which is designed in such a way that it determines from the range values E and the speed values v or the time difference between the entry and exit time points tₐ−t_{b} the passage distance d, which is fed to a downstream difference generator 8. The difference generator 8 is also connected to the evaluation and storage unit 6 and receives from it a value for a driven distance s. From the driven distance s and the passage distance d, the vehicle length L is determined by forming a difference in the difference generator 8. The determined vehicle length L is provided to a comparator 9, which is connected to the difference generator 8 and the evaluation and control unit 6. The comparator 9 is designed in such a way that it assigns the determined vehicle length L received from the difference generator 8 and the signal form M each to a vehicle class and then compares whether the same vehicle class was assigned, which serves optionally as confirmation of the vehicle class.

So that the vehicle length L and the signal form M can each be allocated to a vehicle class, typical vehicle lengths Lₘ and typical signal forms Mₘ, which can each be allocated uniquely to a vehicle class, are stored in the difference generator 8.

If the vehicle class K is confirmed, then it is forwarded together with the speed v to a camera 10 in order to display these values in the camera photograph.

### LIST OF REFERENCE SYMBOLS

A1 First vehicle
A2 Second vehicle
A3 Third vehicle
4 Radar cone
5 Radar device
6 Evaluation and memory unit
7 Computing unit
8 Difference generator
9 Comparator
10 Camera
α Beam spread angle of radar cone 4
β Positioning angle
v Speed
M Signal form
K Classification
E Average range value
Lₘ Stored typical vehicle length
Mₘ Stored typical signal form
a Distance of radar device 5 to roadway
tₐ Time point of entry of a vehicle A into the radar cone 4
t1ₐ Time point of entry of the first vehicle A1 into the radar cone 4
t2ₐ Time point of entry of the second vehicle A2 into the radar cone 4
t3ₐ Time point of entry of the third vehicle A3 into the radar cone 4
t_{b} Time point of exit of a vehicle A out of the radar cone 4
t1_{b} Time point of exit of the first vehicle A1 out of the radar cone 4
t2_{b} Time point of exit of the second vehicle A2 out of the radar cone 4
t3_{b} Time point of exit of the third vehicle A3 out of the radar cone 4
Eₐ Range of a vehicle A from the radar device 5 to time point tₐ
E1ₐ Range of the first vehicle A1 from the radar device 5 to time point t1ₐ
E2ₐ Range of the second vehicle A2 from the radar device 5 to time point t1ₐ
E3ₐ Range of the third vehicle A3 from the radar device 5 to time point t1ₐ
E_{b} Range of a vehicle A from the radar device 5 to time point t_{b}
E1_{b} Range of the first vehicle A1 from the radar device 5 to time point t1_{b}
E2_{b} Range of the second vehicle A2 from the radar device 5 to time point t1_{b}
E3_{b} Range of the third vehicle A3 from the radar device 5 to time point t1_{b}
s Driven distance of a vehicle A through the radar cone 4
s1 Driven distance of the first vehicle A1 through the radar cone 4
s2 Driven distance of the second vehicle A2 through the radar cone 4
s3 Driven distance of the third vehicle A3 through the radar cone 4
e Distance that a vehicle A covers
L Vehicle length of a vehicle A
L1 Vehicle length of the first vehicle A1
L2 Vehicle length of the second vehicle A2
L3 Vehicle length of the third vehicle A3
d Passage distance of a vehicle A through the radar cone 4
d1 Passage distance of the first vehicle A1 through the radar cone 4
d2 Passage distance of the second vehicle A2 through the radar cone 4

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. Method for classifying vehicles with reference to their vehicle length comprising directing a radar beam in the form of a radar cone toward a roadway, said beam having a beam spread angle horizontally oriented at an acute positioning angle at a distance to the roadway and through evaluation of the radar signals generated by reflection on a vehicle traveling on the roadway, a driven distance over which the vehicle reflects the radar beam while traveling, determining from the signals, a range value by means of which a passage distance is determined, over which the vehicle travels through the radar cone and determining the vehicle length by comparing said length with vehicle lengths that are typical for individual vehicle classes, from the difference between the driven distance and the passage distance, in order to classify the vehicle.

2. Method according to claim 1, wherein the driven distance which the vehicle covers during a radar pulse, is determined from the number of reflected radar pulses and the distance determined by the wavelength of the radar pulse and the positioning angle.

3. Method according to claim 1, wherein the driven distance is determined from the passage of time determined by the time points of the entry into and the exit from the radar cone and the measured velocity.

4. Method according to claim 1 wherein a range value is determined, to which a previously stored passage distance is assigned.

5. Method according to claim 1 wherein at the time point of the entry of the vehicle into and at the time point of the exit of the vehicle out of the radar cone range values are detected and the passage distance is calculated by means of the beam spread angle and the positioning angle.

6. Method according to claim 1 wherein the range values are determined by means of the total passage time, and the vehicle path, whose length corresponds to the passage distance is determined from the range values and the speed.

7. Method according to claim 1 wherein the measurement area defined by the beam spread angle is limited in that angle values are determined from the radar signals and only the measured values, to which angle values lying between predetermined angle values are assigned, are used for determining the driven distance and the passage distance.

8. Method according to claim 1 wherein the signal form of the reflected radar beam is stored and compared with previously stored signal forms that are typical for individual vehicle classes, in order to verify the previously determined classification.

9. Method according to claim 1 further comprising making a photograph of the classified vehicle and displaying information on the vehicle length in the photograph.

10. Method according to claim 1 further comprising making a photograph of the classified vehicle and information on the classification is displayed in the photograph.

11. Method according to one of claims 9 or 10, characterized in that a photograph is made only when a speed that is above the maximum speed for the relevant vehicle class is assigned to the classified vehicle.

12. Method according to claim 11, characterized in that a photograph is provided only if a velocity above the speed limit for the respective vehicle class is assigned to the classified vehicle.

13. Device for classifying vehicles with reference to their vehicle length comprising a radar device which directs a radar beam in the form of a radar cone with a beam spread angle horizontally over a roadway at an acute positioning angle at a distance to the roadway and which receives a radar beam reflected by a vehicle and which forms radar signals, and an evaluation and memory unit connected to said radar device for determining the driven distance, over which a vehicle reflects the radar beam while traveling, from the radar signals, said evaluation and memory unit being designed to form at least one range value by means of which a passage distance over which the vehicle travels through the radar cone is determined in a downstream computing unit and a difference generator which is connected to the computing unit and the evaluation and memory unit and which determines the vehicles length from the difference between the driven distance and the passage distance, provides this length to a downstream comparator which is connected to the difference generator and which is suitable for comparing the determined vehicle length with stored vehicle lengths that are typical for defined vehicle classes, in order to classify the vehicle.

14. Device according to claim 13, wherein said evaluation and memory unit is provided for storing the signal form of the reflected radar beam, and wherein said comparator is connected to the evaluation and memory unit and compares the signal form with stored signal forms that are typical for certain vehicle classes, in order to verify the classification made by means of the vehicle length.

15. Device according to claim 13, further comprising a camera for making a photograph of the classified vehicle, wherein and the vehicle length and/or the classification of the vehicle is indicated in the photograph.
